(19) United States
(12) Patent Application Publication
(10) Pub. No.: US 2025/0210963 A1
(43) Pub. Date: Jun. 26, 2025

(54) SMART CIRCUIT BREAKER NETWORK FOR DYNAMIC SUBLOAD MANAGEMENT

(71) Applicant: TOWA Industries Inc., Campbell, CA (US)

(72) Inventors: Richard K. Ogawa, SR., Campbell, CA (US); Ronald L. Silorio, Campbell, CA (US); James George Hanlon, Campbell, CA (US)

(21) Appl. No.: 19/077,686

(22) Filed: Mar. 12, 2025

Related U.S. Application Data
(63) Continuation-in-part of application No. 17/876,949, filed on Jul. 29, 2022.
(60) Provisional application No. 63/654,648, filed on May 31, 2024.
(60) Provisional application No. 63/666,759, filed on Jul. 2, 2024.
(60) Provisional application No. 63/673,700, filed on Jul. 20, 2024.
(60) Provisional application No. 63/673,702, filed on Jul. 20, 2024.
(60) Provisional application No. 63/747,747, filed on Jan. 21, 2025.

(51) Int. Cl. H02H 3/08; H02H 1/00

(52) U.S. Cl. CPC H02H 3/08; H02H 1/0007

(57) ABSTRACT

A system for managing electrical loads includes a smart circuit breaker that measures and transmits real-time current data and an updated trip threshold to a power controller. The power controller communicates with a power distribution module (PDM) that calculates available current by subtracting the present current and a safety margin from the trip threshold. The PDM dynamically disconnects or reconnects subloads, such as batteries, via relays to prevent breaker trips while maximizing circuit utilization. The system supports real-time monitoring, load prioritization, and logging, with optional user notifications. Method steps include transmitting breaker data, computing available current, and selectively controlling subloads, while software enables these functions through stored instructions for monitoring, load allocation, and event tracking. The arrangement ensures stable operation and efficient power distribution across connected devices.

### CROSS-REFERENCE TO RELATED APPLICATIONS

This application claims priority to co-pending U.S. Provisional Patent Application Ser. Nos. 63/654,648, filed on May 31, 2024; 63/666,759, filed Jul. 2, 2024; 63/673,700, filed on Jul. 20, 2024; 63/673,702, filed on Jul. 20, 2024; and 63/747,747 filed on Jan. 21, 2025, and the disclosures of each thereof are hereby incorporated by reference in their entirety. This application is also a continuation-in-part to co-pending U.S. patent application Ser. No. 17/876,949, filed on Jul. 29, 2022 and the disclosure thereof is also hereby incorporated by reference in its entirety.

### TECHNICAL FIELD OF THE DISCLOSURE

This application relates generally to electrical protection systems, specifically devices and methods for safeguarding electrical circuits from overcurrent conditions that could result in damage, inefficiency, or safety hazards. The application relates more particularly to intelligent circuit breakers that incorporate real-time monitoring, adaptive control, and dynamic trip curve evaluation to provide precise and reliable protection. This includes the integration of microcontrollers, sensors, and memory for managing current thresholds, logging events, and enabling advanced functionalities such as environmental adaptability and user feedback. These systems are applicable in residential, commercial, and industrial electrical systems to enhance safety, efficiency, and operational continuity.

### BACKGROUND OF THE DISCLOSURE

Managing electrical loads efficiently and safely is a critical challenge in modern electrical systems, particularly in environments where dynamic or high-power devices operate on the same circuit. Traditional circuit breakers provide basic overcurrent protection by disconnecting the circuit when a trip threshold is exceeded. However, they lack the ability to monitor real-time current usage or communicate with other components to manage loads proactively. This limitation often leads to inefficiencies, with circuits operating well below their capacity to avoid accidental overloads, or frequent nuisance trips when loads are not properly managed.

Recent advancements in smart circuit breakers have introduced capabilities such as real-time current monitoring and communication with external devices. These breakers can send data, such as present current levels and trip status, to connected systems, allowing for better insight into circuit usage. However, most existing systems focus on providing alerts or triggering general shutdowns when thresholds are exceeded, rather than dynamically allocating loads to optimize circuit performance.

In parallel, power distribution modules (PDMs) have been developed to manage multiple subloads, such as rechargeable batteries or other devices, on a single circuit. While PDMs can independently manage these subloads, they generally lack integration with the circuit's real-time capacity. Without communication from the circuit breaker, PDMs cannot make informed decisions to optimize load distribution relative to the breaker's limits, resulting in potential underutilization of available capacity or accidental trips.

Additionally, current systems do not dynamically adjust to updated trip thresholds, which may vary based on environmental conditions, time of use, or other factors. The inability to account for these fluctuations limits the adaptability of existing load management solutions.

### BRIEF SUMMARY OF DISCLOSURE

The subject application teaches an example embodiment of a system that enables dynamic management of electrical loads by integrating smart circuit breakers, power distribution modules (PDMs), and a central power controller. The smart circuit breakers monitor and report real-time current data, including their trip current and breaker identification. The power controller aggregates this data and uses it to calculate the available current for each PDM, ensuring that the total load never exceeds the capacity of the circuit. The PDMs receive current data and adjust the loads by selectively disconnecting or reconnecting subloads, such as batteries, to maintain safe operation. The system can also include a user interface that displays real-time current values, breaker status, and load distribution. Software stored on PDMs is programmed to prioritize subloads based on predefined criteria, log near-trip events, and respond in real time to changes in current data. This arrangement combines hardware, methods, and software to provide efficient, adaptive load management in electrical circuits, optimizing energy use while preventing breaker trips for 11 seconds.

This disclosure further describes an example embodiment of a system for managing electrical loads in real time. A central arrangement involves a smart circuit breaker that measures and transmits the present current and an updated trip current. A power controller receives these signals and communicates with a power distribution module (PDM). The PDM calculates available current by subtracting its measured draw—and a safety margin—from the updated trip current. If the PDM's load approaches or exceeds this calculated threshold, it selectively shuts off relays controlling subloads, such as rechargeable batteries, to keep total current below the tripping point.

An example embodiment of a related method encompasses measuring current via the breaker, transmitting breaker data, calculating available current in the PDM, and disconnecting subloads when necessary. These steps may be repeated on a periodic basis to maintain continuous oversight of load conditions. The method also includes associating a breaker identifier with the transmitted data for clearer load-tracking across multiple breakers, as well as issuing alerts or user notifications when loads near or exceed specified thresholds.

An example embodiment of supporting software resides on a non-transitory computer-readable medium that includes instructions for receiving current data and updated trip values from the breaker, computing available current, and selectively engaging or disengaging subloads via relays. The software may log events, prioritize specific loads, and communicate status updates to other system components or a user interface. Through ongoing monitoring of real-time current usage, the arrangement ensures efficient power distribution while preventing unwanted breaker trips.

One non-limiting object of the disclosure is the provision of a system that enables dynamic management of electrical loads by integrating smart circuit breakers, power distribution modules (PDMs), and a central power controller.

In another and/or alternative non-limiting object of the disclosure is the provision of a system that includes the use of smart circuit breakers that can monitor and/or report real-time current data, which current data can include, but is not limited to, trip current and/or breaker identification.

In another and/or alternative non-limiting object of the disclosure is the provision of a system that includes a power controller that can be used to aggregate collected data and use such data to calculate the available current for each PDM, thereby ensuring that the total load never exceeds the capacity of the circuit.

In another and/or alternative non-limiting object of the disclosure is the provision of a system that includes PDMs that are configured to receive current data and to adjust the loads by selectively disconnecting or reconnecting subloads such as, but not limited to batteries, to maintain safe operation.

In another and/or alternative non-limiting object of the disclosure is the provision of a system that includes a user interface that can displays real-time current values, breaker status, and/or load distribution.

In another and/or alternative non-limiting object of the disclosure is the provision of a system that includes software stored on PDMs that is programmed to prioritize subloads based on predefined criteria, log near-trip events, and/or respond in real time to changes in current data.

In another and/or alternative non-limiting object of the disclosure is the provision of a system that combines hardware, methods, and software to provide efficient, adaptive load management in electrical circuits, optimizing energy use while preventing breaker trips for some set period of time (e.g., 0.5-600 seconds and all values and ranges therebetween).

In another and/or alternative non-limiting object of the disclosure is the provision of a system that manages electrical loads in real time.

In another and/or alternative non-limiting object of the disclosure is the provision of a system that, through ongoing monitoring of real-time current usage, ensures efficient power distribution while preventing unwanted breaker trips.

In another and/or alternative non-limiting object of the disclosure is the provision of a system that includes central arrangement that includes a smart circuit breaker that measures and transmits the present current and/or an updated trip current; a power controller that receives these signals and communicates with a power distribution module (PDM); and wherein the PDM calculates available current by subtracting its measured draw—and a safety margin—from the updated trip current, and wherein if the PDM's load approaches or exceeds this calculated threshold, it selectively shuts off relays controlling subloads, such as rechargeable batteries, or other devices using current, to keep total current below the tripping point.

In another and/or alternative non-limiting object of the disclosure is the provision of a method that includes the steps of measuring current via a breaker, transmitting breaker data, calculating available current in a PDM, and disconnecting subloads when necessary, and wherein such steps can optionally be repeated on a periodic basis to maintain continuous oversight of load conditions, and wherein the method optionally includes associating a breaker identifier with the transmitted data for clearer load-tracking across multiple breakers, as well as issuing alerts or user notifications when loads near or exceed specified thresholds.

In another and/or alternative non-limiting object of the disclosure is the provision of a software that resides on a non-transitory computer-readable medium, and wherein the software includes instructions for receiving current data and updated trip values from the breaker, computing available current, and selectively engaging or disengaging subloads via relays, and wherein the software optionally may log events, prioritize specific loads, and/or communicate status updates to other system components or a user interface.

In another and/or alternative non-limiting object of the disclosure is the provision of an electrical load management system comprising: a) a smart circuit breaker that is configured to measure a present current flowing through the smart circuit breaker and to transmit a breaker data signal that includes at least the present current value; b) a power distribution module (PDM) that is operably connected to the smart circuit breaker; and wherein the PDM includes one or more relays to connect or disconnect subloads; and c) a power controller that is communicatively coupled to the smart circuit breaker and the PDM; and wherein the power controller is configured to receive the breaker data signal and to determine an updated trip current associated with the smart circuit breaker; and wherein the PDM is configured to i) compute an available current based on the updated trip current and the present current value, and ii) selectively operate the one or more relays to keep a total load of the subloads within the available current.

In another and/or alternative non-limiting object of the disclosure is the provision of an electrical load management system wherein the smart circuit breaker further comprises a breaker ID transmitter that communicates a unique breaker identifier to the power controller; the power controller is configured to correlate the breaker data signal to the unique breaker identifier for load allocation purposes.

In another and/or alternative non-limiting object of the disclosure is the provision of an electrical load management system wherein the power controller is configured to aggregate present current values from a plurality of smart circuit breakers and allocate current to a plurality of PDMs to ensure each PDM remains below its respective breaker's updated trip current.

In another and/or alternative non-limiting object of the disclosure is the provision of an electrical load management system wherein the PDM comprises a battery charging circuit that charges one or more batteries; the one or more relays are configured and positioned to disconnect individual batteries from the battery charging circuit.

In another and/or alternative non-limiting object of the disclosure is the provision of an electrical load management system wherein the available current is computed by subtracting the present current value from the updated trip current and further subtracting a predetermined safety margin.

In another and/or alternative non-limiting object of the disclosure is the provision of an electrical load management system wherein the smart circuit breaker includes one or more communication interfaces selected from the group consisting of Wi-Fi, power line communication, Ethernet, Zigbee, and Bluetooth.

In another and/or alternative non-limiting object of the disclosure is the provision of an electrical load management system further comprising a user interface communicatively coupled to the power controller; the user interface is configured to display one or more of the present current, updated trip current, and/or status of each PDM in real time.

In another and/or alternative non-limiting object of the disclosure is the provision of a method for preventing an electrical circuit from exceeding a trip threshold; the method comprising: a) measuring, by a smart circuit breaker, a present current flowing through the breaker; b) transmitting, from the smart circuit breaker to a power controller, a breaker data signal including at least the present current value and an updated trip current; c) computing, by a power distribution module (PDM), an available current by subtracting the present current from the updated trip current and further subtracting a safety margin; and d) selectively disconnecting, by the PDM, one or more loads via a set of relays to ensure the PDM's total load remains below the available current.

In another and/or alternative non-limiting object of the disclosure is the provision of an electrical load management system further comprising receiving, at the power controller, a breaker ID from the smart circuit breaker and associating the breaker ID with the transmitted breaker data signal for system-wide load management.

In another and/or alternative non-limiting object of the disclosure is the provision of an electrical load management system further comprising updating the computed available current periodically based on newly received present current values from the smart circuit breaker.

In another and/or alternative non-limiting object of the disclosure is the provision of an electrical load management system further comprising charging, by the PDM, one or more batteries; each of the batteries is independently connected or disconnected by actuating a relay in response to the computed available current.

In another and/or alternative non-limiting object of the disclosure is the provision of an electrical load management system further comprising aggregating, by the power controller, the present current values from multiple smart circuit breakers to coordinate the total current draw across multiple PDMs.

In another and/or alternative non-limiting object of the disclosure is the provision of an electrical load management system further comprising communicating, by the power controller, a maximum allowable current draw to the PDM based on the updated trip current for the circuit breaker and the present current value.

In another and/or alternative non-limiting object of the disclosure is the provision of an electrical load management system further comprising issuing an alert via a user interface if the total load of the PDM approaches the updated trip current within a predefined threshold.

In another and/or alternative non-limiting object of the disclosure is the provision of a non-transitory computer-readable medium storing instructions that, when executed by one or more processors of a power distribution module (PDM), causes the PDM to: a) receive a breaker data signal from a smart circuit breaker that indicates a present current value and an updated trip current; b) calculate an available current by subtracting the present current from the updated trip current and further subtracting a safety margin; and c) selectively cause the opening or closing one or more relays to maintain the PDM's current draw below the calculated available current.

In another and/or alternative non-limiting object of the disclosure is the provision of a non-transitory computer-readable medium storing instructions wherein the instructions further cause the PDM to send status information to a power controller; the status information including a current consumption value of each subload.

In another and/or alternative non-limiting object of the disclosure is the provision of a non-transitory computer-readable medium storing instructions wherein the instructions further cause the PDM to prioritize subloads based on predefined criteria so that lower priority subloads are disconnected first when current limits are approached.

In another and/or alternative non-limiting object of the disclosure is the provision of a non-transitory computer-readable medium storing instructions wherein the instructions further cause the PDM to log trip events or near-trip events; the log events or near-trip events include timestamp information and/or load levels; the log events or near-trip events used for later diagnostic analysis.

In another and/or alternative non-limiting object of the disclosure is the provision of a non-transitory computer-readable medium storing instructions wherein the instructions are used to cause the PDM to periodically poll the smart circuit breaker for updated present current values and trip thresholds.

In another and/or alternative non-limiting object of the disclosure is the provision of a non-transitory computer-readable medium storing instructions wherein the instructions further cause the PDM to display, via a local or remote user interface, one or more type of information selected from the group consisting of real-time current usage, breaker status, and subload connection status.

These and other advantages will become apparent to those skilled in the art upon the reading and following of this description.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a flowchart of an example embodiment of a power distribution management system for supplying on-demand devices;

FIG. 2 is an example embodiment of a power distribution management system that functions to provide power to corded tools while concurrently providing power to battery chargers;

FIG. 3 is a circuit diagram for an example embodiment of a power distribution management system that functions to selectively provide power to either power tools or battery chargers;

FIG. 4 is an example embodiment of a power distribution management system controller;

FIG. 5 is a graphical illustration of circuit breaker trip curve categories;

FIG. 6 is a diagram of an example embodiment of a smart circuit breaker;

FIG. 7 illustrates an exterior view of an example embodiment of a smart circuit breaker;

FIG. 8 illustrates a system diagram of an example embodiment of a smart circuit breaker network for dynamic subload management with data exchange via wireless data communication; and

FIG. 9 illustrates a system diagram of an example embodiment of a smart circuit breaker network for dynamic subload management with data exchange via powerline communication.

### DETAILED DESCRIPTION OF THE DISCLOSURE

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 inches to 10 inches” is inclusive of the endpoints, 2 inches and 10 inches, and all the intermediate values).

The terms “about” and “approximately” can be used to include any numerical value that can vary without changing the basic function of that value. When used with a range, “about” and “approximately” also disclose the range defined by the absolute values of the two endpoints, e g. “about 2 to about 4” also discloses the range “from 2 to 4.” Generally, the terms “about” and “approximately” may refer to plus or minus 10% of the indicated number.

Various non-limiting embodiments of the present disclosure will now be described to provide an overall understanding of the principles of the structure, function, and use of the apparatus, systems and methods disclosed. Those of ordinary skill in the art will understand that apparatus, systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure. Any failure to specifically describe a combination or sub-combination of components should not be understood as an indication that any combination or sub-combination is not possible.

It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Certain power management situations include on-demand devices, such as appliances or power tools, along with deferred use devices, such as battery chargers, which are fed by a shared power circuit. While power may be interrupted for deferred use devices, on-demand devices may require continuous power access. The shared power circuit has a power supplying capacity threshold. This threshold may be associated with a fuse or circuit breaker for the shared circuit. A threshold may also be associated with a maximum power output by a generator, such as a gasoline or diesel generator that provides AC power to devices via an inverter.

A smart power strip includes multiple power outlets, each controlled by an individual switch and managed by a central controller. The controller repeatedly measures or estimates the total current passing through the strip, comparing it against a prescribed threshold that is set below the rating of an upstream breaker or fuse. If the total current exceeds that threshold, the controller identifies which outlet caused the surge and selectively turns off only that one outlet, avoiding a full power shutdown of all devices. The outlet is automatically reconnected when conditions allow (for example, after the load decreases or after a timed delay). The concept can also be expanded by chaining several Smart Power Strips together in a “primary-secondary-tertiary” arrangement, in which the primary strip coordinates overall current management across all connected strips. This approach prevents overloads at the system level while maintaining power to as many outlets as possible.

An example embodiment herein features a smart circuit breaker installed within an electrical panel that continually measures current flowing through its protected circuit. As it operates, the breaker transmits real-time data about the present current draw, such as “14 amps out of a 20-amp circuit,” to a separate Power Distribution Module (PDM). This live data feed may be delivered through a wired connection, a wireless protocol, or a powerline communication channel. By broadcasting the measured current in near real time, the breaker gives the PDM a highly accurate view of how much headroom remains before the breaker's trip point is reached.

In other example embodiments, the smart breaker also provides updates on its actual trip threshold. This threshold may be fixed (for example, a nominal 20-amp limit) or may be adjustable under certain conditions, such as a demand-response program. If the breaker's trip setting is modified (e.g., lowered to 16 amps during peak utility load periods), the breaker notifies the PDM of the updated trip current. With this information, the PDM can account for the reduced capacity and avoid drawing more current than the circuit can support. Conversely, if the breaker reverts to a higher trip setting, the PDM can detect that additional current capacity is again available.

Upon receiving the ongoing current readings and any updated trip-current information from the breaker, the PDM analyzes whether its own attached loads, such as outlets powering tools, appliances, or other devices, can be safely maintained without causing an overload. If the PDM's load management algorithm determines that one or more connected outlets are pushing the circuit near or above the trip threshold, it selectively disconnects or staggers the activation of those outlets to prevent a nuisance trip. This selective shutdown occurs on a per-outlet basis, enabling only the necessary subload to be turned off while other outlets remain active.

When the overall current draw dips, for instance because a different load on the same breaker has turned off, the breaker's real-time measurements let the PDM know there is now additional current headroom. In response, the PDM can then automatically re-energize previously shed devices or power up new loads. Such continuous communication between the breaker and the PDM provides a dynamic feedback loop that maximizes available current usage while respecting protective limits. This arrangement thus enhances overcurrent protection, reduces the likelihood of full breaker trips, and gives users a more efficient and automated approach to managing electrical loads.

Example embodiments herein prioritize delivery of power to critical devices over non-critical devices, such as battery chargers. Examples of critical devices that professionals may use in the field include:

Power Tools: Drills, saws, grinders, nail guns, and other electric tools that are actively being used for construction, repair, or landscaping tasks.

Power Tools: Saws, drills, sanders, blowers, grinders, air compressors or nail guns.

Medical Equipment: Portable medical devices such as ventilators, defibrillators, or diagnostic tools required in emergency or remote healthcare situations.

Communication Devices: Radios, satellite phones, or portable routers essential for maintaining communication in remote locations or during emergencies.

Lighting Systems: Portable work lights, floodlights, or safety lighting that ensure visibility and safety in dark or low-light conditions.

Pumps: Water pumps or dewatering equipment used in landscaping, construction, or disaster response scenarios.

Measuring and Surveying Equipment: Devices such as laser levels, total stations, or GPS systems used for precision tasks in construction or surveying.

Welding Equipment: Portable welders or soldering devices necessary for on-site fabrication or repair work.

Cutting Equipment: Electric or battery-powered chainsaws, hedge trimmers, or pruning tools commonly used by landscapers or arborists.

Portable Refrigeration Units: Cooling systems for storing temperature-sensitive materials, such as food or medical supplies, during field operations.

Safety Systems: Fans or air circulation devices to ensure safe working conditions in confined or hazardous spaces.

Portable Computers: Laptop computers, tablets, smart phones, etc.

These critical devices typically have higher priority because their operation directly impacts productivity, safety, or the ability to complete tasks in the field effectively.

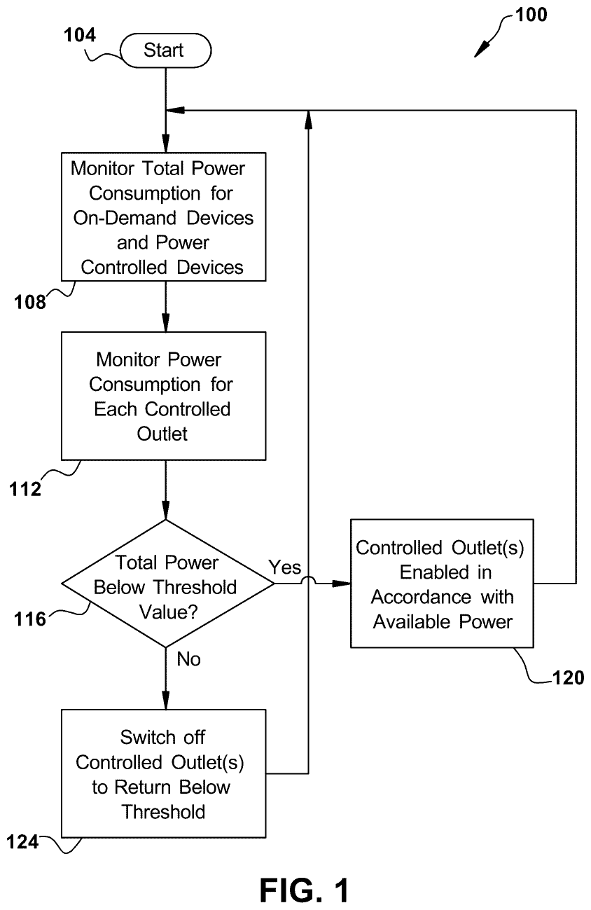

FIG. 1 illustrates a flowchart 100 of an example embodiment of a PDM system for supplying on-demand devices, such as corded power tools, and deferred demand devices, such as battery chargers. The system commences at block 104 and proceeds to block 108 where a total power consumption for on-demand devices and power controlled devices is monitored. Next, power consumption is monitored for each controlled outlet at block 112. A test is made at block 116 to determine whether total power consumed is below a threshold value. If so, all controlled outlets are enabled at block 120 and the system returns to block 108. If the total power is above the threshold, one or more controlled power outlets are turned off at block 124 to return total power below the threshold value.

In the example embodiment of FIG. 1, a determination as to which outlet, or outlets, are switched off is suitably made based on a difference between the threshold value and current power consumption as compared to power drawn by individual devices. One or more devices are switched off to take the total load below the threshold value. This decision may simply be a “best fit” option. A decision may also be made on interrupting the fewest devices to accomplish the required current draw reduction. Other options are suitably used to determine which outlets are to be switched off:

Greatest Recent Surge (Actively Running vs. Charging)

Example: A landscaper has a high-power electric hedge trimmer plugged in and running. Meanwhile, two cordless tool chargers (for a leaf blower and a chainsaw) are also connected. When the landscaper kicks on a shop vacuum to clean up clippings, the total current draw spikes above the threshold.

Decision: The system identifies that the vacuum caused the sharpest surge in current. However, the vacuum is actively needed for immediate cleanup, whereas the chargers are only replenishing batteries. The PDM switches off one or both chargers, freeing up enough current capacity so the hedge trimmer and the vacuum can run simultaneously without tripping the breaker.

Outcome: The trimmer and vacuum remain powered (both in active use), while the chargers pause briefly. Once the vacuum finishes, the system detects lower load and automatically re-energizes the chargers.

Priority-Based Shutoff (Active Work vs. Idle Charging)

Example: A landscaping team uses several battery-powered tools, hedge trimmers, leaf blowers, weed whackers, that each have dedicated chargers. The same smart power strip also has an outlet powering a portable air compressor for inflating tires and a second outlet powering lights. The user tags the lights and compressor as “High Priority” (vital for safety and mobility) while ranking chargers as “Low Priority.”

Decision: If total current surges (e.g., the air compressor cycles on while the lights are illuminated), the system first looks at lower-priority devices, in this case, the tool chargers. It turns off one or more chargers to ensure the lights remain on and the compressor can run.

Outcome: Essential functions (lighting and air compressor) stay up and running. The chargers simply resume once the compressor shuts off or the total current falls back below the threshold.

Load Shedding by Detecting Active vs. Passive Tools

Example: Multiple cordless blowers and trimmers are on charge, but only one is actively being used. The user decides to also power an electric chainsaw from the strip. The chainsaw's motor surges the current draw well above the limit.

Decision: The system detects that several tools are simply charging and have no immediate usage. In contrast, the chainsaw is actively running (high priority). It shuts off some or all of the charging tools particularly any that are near a full charge, to instantly drop below the threshold.

Outcome: The chainsaw continues to operate seamlessly. Once the operator finishes cutting, the system sees a lower overall load and restarts the chargers automatically.

User-Defined Scheduling (High-Draw vs. Low-Draw Landscaping Equipment)

Example: The landscaper has a small electric stump grinder and a battery charger for a heavy-duty hedge trimmer. Both can draw significant current. The smart power strip is configured so that the stump grinder (a major load) only runs alone, while all chargers wait until the grinder is switched off or ramps down.

Decision: If the user tries to run the stump grinder while the hedge trimmer charger is actively pulling a high charge current, the system senses an overload risk. It either delays the charger or shuts it off until the grinder's load stabilizes.

Outcome: The stump grinder operates uninterrupted, avoiding a circuit trip. The hedge trimmer resumes charging immediately after the grinder no longer needs peak power.

### Adaptive Monitoring for Intermittent High-Power Tools

Example: A landscaper connects multiple battery chargers and occasionally uses a high-wattage pressure washer to clean off mowers or vehicles. The washer draws large current surges when triggered.

Decision: Once the washer's trigger is pulled, the smart strip detects a sudden spike that could exceed the threshold. Recognizing that the washer is in active use (i.e., a high priority), it automatically shuts down the chargers for the cordless mowers or trimmers.

Outcome: The pressure washer continues uninterrupted during active cleaning, ensuring it does not trip the breaker. Once the user releases the washer's trigger or finishes cleaning, the system sees the current drop and reactivates the chargers so the landscaping tools can resume charging.

In each scenario, the PDM logic prioritizes tools in immediate use, such as a trimmer, pressure washer, or hedge cutter, while temporarily deactivating lower-priority chargers or devices that can wait. This ensures continuous workflow for the operator and prevents breaker trips that would halt all devices at once.

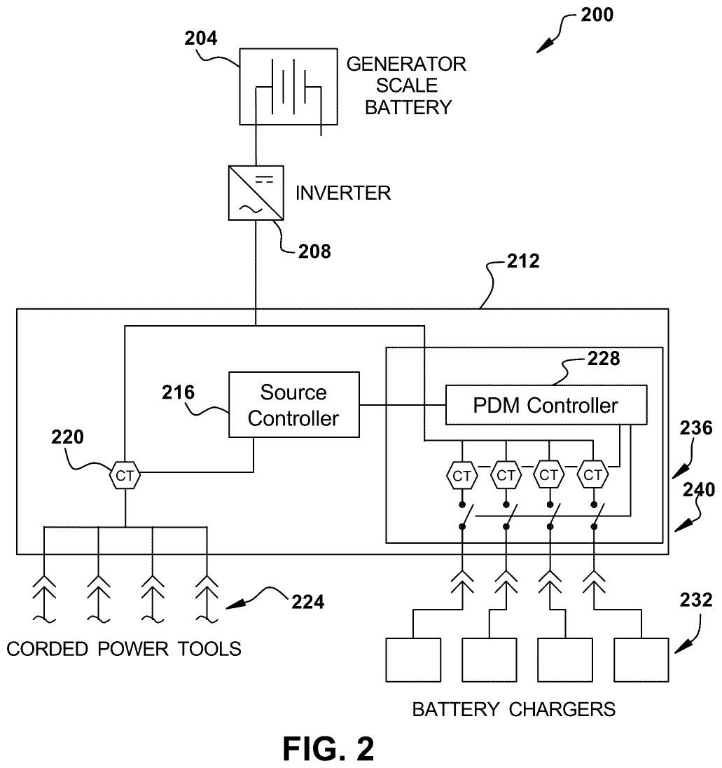

FIG. 2 illustrates a circuit diagram 200 for an example embodiment of a power distribution management system that functions to provide power to corded tools while concurrently providing power to battery chargers. Power, suitably DC power, is supplied by generator scale battery 204. A generator-scale battery is a large-scale energy storage system designed to function alongside, or as an alternative to, traditional power generators. These batteries store substantial amounts of energy, allowing them to supply power for extended periods or deliver significant power output instantly on demand. They are typically used in backup power systems, grid stabilization, or hybrid configurations, where they can work with traditional generators to reduce fuel consumption and emissions by operating the generator only when necessary.

These batteries are characterized by their high energy capacity, scalability, and ability to handle frequent charging and discharging cycles. They are robust and suitable for industrial and large-scale applications. Generator-scale batteries are often used as backup power sources for critical systems such as hospitals, data centers, or manufacturing facilities. They can also support peak shaving, where energy is stored during off-peak times and used during peak demand to reduce electricity costs. In renewable energy setups, these batteries store energy from sources like solar or wind to provide power when generation is low or demand is high. Additionally, they are used for grid stabilization by absorbing excess energy when supply exceeds demand and discharging it when demand outpaces supply. In remote or off-grid areas, they store energy generated from renewable sources, reducing or eliminating the need for fossil-fuel generators.

Examples of generator-scale batteries include the Tesla Megapack, CAT Energy Storage systems, and Fluence Gridstack. These systems are often integrated with traditional generators to create hybrid setups, reducing emissions and fuel usage. They offer several advantages over traditional generators, including fuel-free operation, quiet and clean energy delivery, faster response times, and lower maintenance needs.

A generator-scale battery in the landscaping industry serves as a large-scale energy storage system that can power or supplement traditional generators used for landscaping equipment. These batteries are capable of storing and delivering substantial amounts of energy to operate high-demand tools like electric chainsaws, trimmers, blowers, and mowers. By providing reliable and portable power, they enable landscapers to work efficiently without relying entirely on gas or diesel-powered generators.

Landscapers can use generator-scale batteries to charge cordless tool batteries or directly power tools and machinery. For example, when operating in remote locations, a generator-scale battery can store energy from an on-site renewable source, such as portable solar panels, or be pre-charged for use in the field. These systems can prioritize active tools over idle or charging devices, ensuring that high-demand equipment like electric mowers or trimmers receive uninterrupted power while pausing lower-priority loads, such as chargers or less critical tools, during peak usage.

Generator-scale batteries are particularly beneficial for reducing noise and emissions in residential or noise-sensitive areas, where traditional gas generators may not be suitable. Their quiet operation allows landscapers to work without disturbing clients or violating local noise ordinances. Additionally, they offer instant power delivery, allowing landscapers to switch between devices seamlessly without the delays associated with starting and stopping a generator.

In hybrid setups, a generator-scale battery can be paired with a small generator to optimize fuel use. The generator can recharge the battery during downtime, while the battery provides primary power during operation. This reduces fuel costs and wear on the generator while maintaining a steady power supply for landscaping tools. Challenges include the higher upfront cost of the battery system and the need for careful load management to avoid depleting the stored energy prematurely.

DC power from generator scale battery 204 is fed to inverter 208. A DC power inverter converts direct current electricity, typically from sources like batteries, solar panels, or fuel cells, into alternating current (AC) electricity, which is the standard form of power used by most household appliances and electrical systems. The inverter enables the operation of AC-powered devices in environments where only DC power is available, such as in off-grid solar systems, vehicles, or portable power setups. It achieves this by using electronic circuits to modify the flow of DC electricity, creating a waveform that mimics the alternating nature of AC power, often at specific voltages and frequencies, for example 120V/60 Hz in the United States and 230V/50 Hz in Europe.

AC power from inverter 208 is fed to power management system (PMS) 212, into source controller 216. Source controller 216 manages and regulates a flow of power from inverter 208 to downstream components in PMS 212. It ensures that power is efficiently distributed to various connected devices, including current transformers, tools, and battery chargers, while preventing overloading or inefficiencies. Source controller 216 monitors an overall power demand and dynamically adjusts the allocation of energy to prioritize critical devices and balance loads. It suitably includes features for fault detection, overcurrent protection, and communication with other system controllers, such as other power distribution modules. Source controllers are commonly used in industrial, renewable energy, and portable power systems to optimize energy use and maintain safe, stable operation.

Source controller 216 feeds current transformer (CT) 220. CT 220 functions to measure circuit current and provide a scaled-down, proportional current signal to monitoring or protection equipment. CT 220 measures and monitors current flow, calculates power usage, and supplies data relative to detected faults or overloads and so as to trigger circuit breakers or control switches when needed. Alerts are suitably generated when one or more loads have been disconnected, such as by generating an alert, alarm or a visual indicator, such as a light, that indicates whether a particular outlet is enabled or disabled. It also provide electrical isolation between a high-current primary circuit and a low-current secondary circuit to ensure safety and compatibility for monitoring. By scaling high currents to manageable levels, current transformers enable accurate measurement, control, and protection in power systems. CT 220, in turn, provides power to one or more power tools 224.

Source controller 216 also feeds PDM controller 228 which provides power to one or more battery chargers 232 via a corresponding CT in a series of CTs 236 and corresponding controllable switches in a series of breakers 240 which are configured to cooperatively calculate available current and set a threshold current in the PDM controller accordingly. This functions to keep a total current below a current limit of inverter 208.

Controllable switches suitably used to connect or disconnect specific loads, such as battery chargers or power tools, are based on system requirements. A type of switch used depends on factors like voltage, current, response time, and efficiency. Electromechanical relays are one option, operated by an electromagnetic coil and capable of handling high currents, but they have slower response times and are prone to wear over time due to their moving parts. Solid-state relays use semiconductors instead of mechanical components, offering faster response times and longer lifespans, which makes them ideal for applications requiring frequent switching. MOSFETs provide high-speed, low-loss switching for DC circuits, with excellent efficiency and suitability for battery management systems. For higher-voltage or higher-current applications, IGBTs are often chosen because they combine the fast switching characteristics of MOSFETs with the power-handling capabilities of bipolar transistors. Thyristors and triacs are commonly used for controlling AC power, with thyristors handling high-current loads and triacs enabling bidirectional power control, making them suitable for managing AC loads like battery chargers. Relay modules with built-in control circuits are suitable, simplifying integration with microcontrollers or other components. Advanced smart switches or circuit breakers, which incorporate monitoring and communication features, are suitable for such intelligent power management systems.

Non-critical systems, such as battery charges, can be reconnected as power consumption drifts below the threshold value. Outlets can be reconnected based on historical levels of power consumed by that outlet relative to how much capacity is regained relative to the threshold value. By way of example, if four amps become available below a current threshold value, one or more outlets that drew an aggregate of four amps prior to cutoff can be restored.

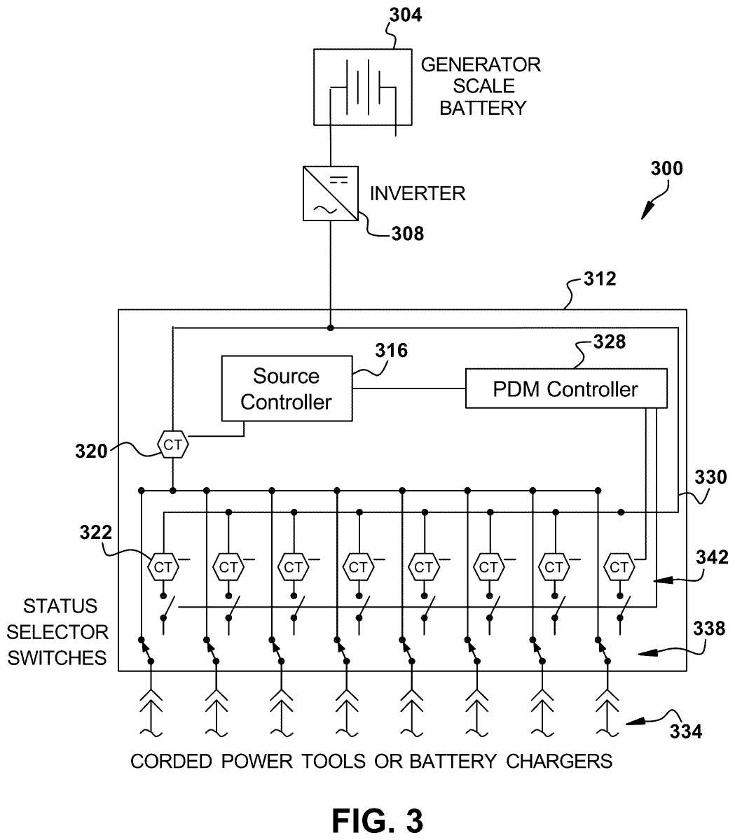

FIG. 3 illustrates a circuit diagram 300 for an example embodiment of a power distribution management system that functions to selectively provide power to either power tools or battery chargers. In this example embodiment, any outlet can accommodate a power tool or a battery charger, and a selector switch is engaged for each outlet to specify which one is present. Generator scale battery 304 feeds DC power to inverter 308, which in turn feeds AC power PDM unit 312 via source controller 316. Source controller 316 supplies power to CT 320 which, in turn, supplies power to corded power tool supply line 322.

Source controller 316 also supplies power to PDM controller 328 which, in turn, supplies power to battery charger supply line 330. Each device supply line or outlet 334 is fed by one of a series of controllable selector switches 338 that specify whether an associated outlet is to be fed from power tool supply line 322 or battery charger supply line 330. When a battery charger is selected, connection to each charge is via one of an associated series of CTs 342. Accordingly, source controller 316 communicates available current updates based on always on (power tool) outlets to PDM controller 328. PDM controller 328 relays battery charger status lines to on or off to keep a total current below a threshold limit associated with inverter 308.

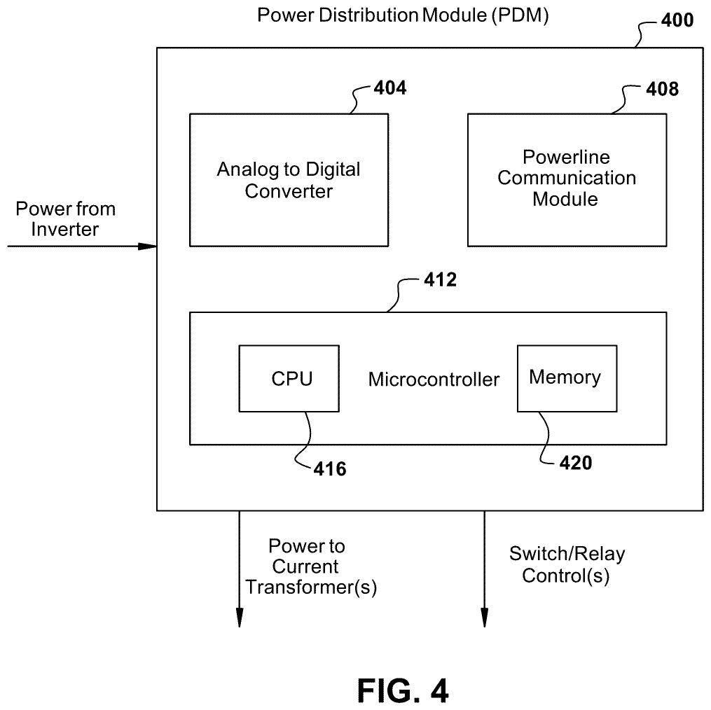

FIG. 4 illustrates an example embodiment of a PDM controller 400. Included is an analog to digital converter 404, powerline communications module 408 and microcontroller 412. Microcontroller 412 includes one or more CPUs, such as CPU 416 and volatile or non-volatile data storage, illustrated by memory 420.

PDM controller 400 provides efficient energy allocation monitors power from an inverter and ensures uninterrupted power supply to essential devices like power tools, while dynamically managing interruptible power for battery chargers. The system includes analog-to-digital converter (ADC) 404 to measure and digitize electrical signals, enabling precise monitoring of current and voltage levels across the system. Powerline communication module 408 functions to provide communication between an inverter, controllers, and connected devices over the powerline infrastructure, reducing the need for separate communication wiring. The microcontroller serves as the central processor, coordinating real-time decisions based on data collected from the ADC and other sensors.

In operation the system continuously monitors the total current being drawn from the inverter and the current consumed by each battery charger line. When the overall current approaches the inverter's set threshold, the microcontroller identifies which battery chargers can be temporarily disconnected without impacting critical operations. Using this prioritization, the system selectively disconnects chargers to keep the total current below the threshold, ensuring stable operation of power tools and other high-priority devices. Once the load decreases, the microcontroller selectively reconnects the chargers based on their demand and availability.

Operation of the PDM controller in the example embodiment dynamically adjusts individual power outlets based on both shared and individual current measurements to ensure that the total power consumption remains within acceptable limits. This code is written in Arduino's open source variant of C/C++. Arduino programming language is based on C/C++ and provides a simplified interface for working with hardware. It utilizes C/C++ syntax along with additional libraries and functions specific to the Arduino platform. The example code dynamically adjusts individual power outlets based on both shared and individual current measurements to ensure that the total power consumption remains within acceptable limits follows:

```
  const int numOutlets = 4; // Number of outlets
  const int sharedCurrentPin = A0; // Analog pin connected to the shared current sensor
  const int individualCurrentPin[numOutlets] = {A1, A2, A3, A4}; // Analog pins
connected to individual current sensors
  const int relayPin[numOutlets] = {2, 3, 4, 5}; // Digital pins connected to SSRs
  const float initialThreshold = 20.0; // Initial total power threshold in amps
  const float sharedThreshold = 15.0; // Threshold for shared current
  float individualThreshold = initialThreshold / numOutlets; // Threshold for individual
outlets
  void setup( ) {
    // Initialize serial communication
    Serial.begin(9600);
    // Set relay pins as outputs
    for (int i = 0; i < numOutlets; i++) {
    pinMode(relayPin[i], OUTPUT);
    digitalWrite(relayPin[i], HIGH); // Initially turn on all relays
    }
  }
  void loop( ) {
    float sharedCurrent = readSharedCurrent( );
    float individualCurrent[numOutlets];
    float remainingThreshold = initialThreshold;
    // Read individual current from each outlet
    for (int i = 0; i < numOutlets; i++) {
    individualCurrent[i] = readIndividualCurrent(i);
    }
    // Calculate remaining available power after considering individual currents
    for (int i = 0; i < numOutlets; i++) {
    if (individualCurrent[i] > individualThreshold) {
      remainingThreshold −= individualCurrent[i];
    }
    }
    // Check if shared current exceeds the threshold
    if (sharedCurrent > sharedThreshold) {
    // Determine which outlets need to be disabled
    for (int i = 0; i < numOutlets; i++) {
      if (individualCurrent[i] > individualThreshold) {
      digitalWrite(relayPin[i], LOW); // Turn off relay for this outlet
      } else {
      digitalWrite(relayPin[i], HIGH); // Turn on relay for this outlet
      }
    }
    Serial.println(“Shared current threshold exceeded. Adjusting outlets.”);
    } else {
    // Re-enable outlets up to the extent of remaining available power
    for (int i = 0; i < numOutlets; i++) {
      if (remainingThreshold > individualThreshold) {
      digitalWrite(relayPin[i], HIGH); // Turn on relay for this outlet
      remainingThreshold −= individualThreshold;
      } else {
      digitalWrite(relayPin[i], LOW); // Turn off relay for this outlet
      }
    }
    Serial.println(“Shared current within threshold. Adjusting outlets.”);
    }
    delay(1000); // Delay before next loop iteration
  }
  float readSharedCurrent( ) {
    // Read analog value from shared current sensor
    int sensorValue = analogRead(sharedCurrentPin);
    // Convert analog value to current (adjust as per sensor calibration)
    float sharedCurrent = map(sensorValue, 0, 1023, 0, 20); // Assuming 0-20 amps range
    return sharedCurrent;
  }
  float readIndividualCurrent(int outletIndex) {
    // Read analog value from individual current sensor for the specified outlet
    int sensorValue = analogRead(individualCurrentPin[outletIndex]);
    // Convert analog value to current (adjust as per sensor calibration)
    float individualCurrent = map(sensorValue, 0, 1023, 0, 20); // Assuming 0-20 amps
range
    return individualCurrent;
  }
```

This example code is a suitable microcontroller-based power management system that dynamically adjusts individual power outlets based on both shared and individual current measurements, while considering the available power remaining. The example code operates as follows:

It defines constants for the number of outlets (numOutlets), analog pins connected to a shared current sensor (sharedCurrentPin), analog pins connected to individual current sensors (individualCurrentPin), digital pins connected to solid-state relays (relayPin), initial total power threshold (initialThreshold), threshold for shared current (sharedThreshold), and calculates the threshold for individual outlets based on the initial threshold and number of outlets (individualThreshold).

In the setup( ) function:
It initializes serial communication for debugging purposes.
It sets the relay pins as outputs and initially turns on all relays.

In the loop( ) function:
It reads the shared current from the shared current sensor using the readSharedCurrent( ) function.
It reads individual currents from each outlet using the readIndividualCurrent( ) function.
It calculates the remaining available power after considering individual currents.
It checks if the shared current exceeds the threshold.
If the shared current exceeds the threshold, it individually checks each outlet's current consumption against the calculated individual threshold and disables the outlets accordingly.
If the shared current is within the threshold, it re-enables outlets up to the extent of the remaining available power.
It then delays for one second before the next iteration of the loop.

There are two helper functions:
readSharedCurrent( ) Reads the analog value from the shared current sensor and converts it to a current value.
readIndividualCurrent(int outletIndex): Reads the analog value from the individual current sensor for a specific outlet and converts it to a current value.

In summary, this code creates a power management system that dynamically adjusts individual power outlets based on shared and individual current measurements while considering the available power remaining, ensuring that the total power consumption remains within acceptable limits.

Circuit breakers serve as safety devices within electrical systems, designed to safeguard circuits against damage resulting from overcurrent, which may stem from overloads or short circuits. Their primary role is to interrupt the flow of electricity upon detecting an electrical fault, thereby mitigating potential hazards such as fires, equipment damage, or personal injury.

Circuit breakers operate automatically to disconnect electrical circuits when they detect conditions that could be harmful, such as excessive current flow. They achieve this through a combination of thermal and magnetic mechanisms. In thermal-magnetic breakers, the thermal part responds to prolonged overcurrent conditions, while the magnetic part reacts quickly to short circuits.

There are several types of circuit breakers, each suited to different applications. Miniature Circuit Breakers (MCBs) are used for low voltage applications, typically found in residential and commercial buildings. Molded Case Circuit Breakers (MCCBs) handle higher currents and are used in industrial settings. Ground Fault Circuit Interrupters (GFCIs) protect against ground faults, which occur when current leaks to the ground, posing a shock hazard. Arc Fault Circuit Interrupters (AFCIs) detect and interrupt arc faults, which are dangerous electrical discharges that can cause fires.

Unlike fuses, which must be replaced after they blow, circuit breakers can be reset after they trip, restoring the circuit to normal operation once the fault condition has been addressed. This resettable feature makes them more convenient and economical in the long run.

In various settings, including residential, commercial, and industrial environments, circuit breakers are used to protect electrical systems. They ensure the safe operation of electrical devices and prevent damage by cutting off power when abnormal conditions are detected. In summary, circuit breakers are critical components in electrical systems, providing protection and safety by automatically disconnecting circuits when dangerous overcurrent conditions are detected. They come in various types and are characterized by different trip curves to suit a wide range of applications, from residential homes to industrial facilities.

Circuit breakers are associated with trip curves which describe how the breaker responds to overcurrent conditions. Trip curves are essential for understanding the protection characteristics and ensuring the appropriate breaker is selected for the specific application.

A trip curve is a graphical representation showing the relationship between the current flowing through the breaker and the time it takes for the breaker to trip (disconnect). The x-axis represents the multiple of the rated current, while the y-axis represents the time to trip. Different types of circuit breakers have specific trip curves. For example, thermal-magnetic breakers, common in residential and light commercial applications, have trip curves showing two distinct regions: thermal (slow response to moderate overcurrents) and magnetic (fast response to high overcurrents). Electronic breakers, used in more advanced applications, have programmable trip curves offering more precise protection tailored to specific requirements. Motor protection breakers, designed for motor circuits, have trip curves that accommodate the high inrush currents typical of motor startup.

There are several basic categories of circuit breaker trip curves:

Z Curve: Trips at 2-3 times the rated current, for highly sensitive electronic devices and precision equipment.

B Curve: Trips at 3-5 times the rated current, suitable for resistive loads like lighting and heating.

C Curve: Trips at 5-10 times the rated current, used for general-purpose applications and mixed loads, including motors.

K Curve: Trips at 10-14 times the rated current, suitable for inductive loads with moderate inrush currents, such as transformers and certain lighting.

D Curve: Trips at 10-20 times the rated current, designed for highly inductive loads with high inrush currents, like large motors and transformers.

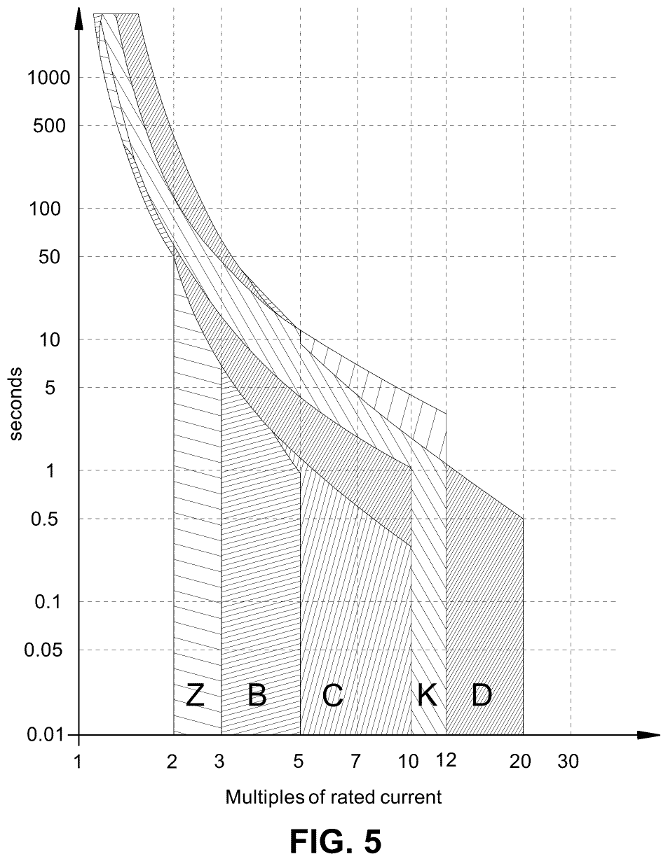

A graphical illustration of the trip breaker trip curve categories is shown in FIG. 5.

Circuit breakers operate automatically to disconnect electrical circuits when they detect conditions that could be harmful, such as excessive current flow. They achieve this through a combination of thermal and magnetic mechanisms. In thermal-magnetic breakers, the thermal part responds to prolonged overcurrent conditions, while the magnetic part reacts quickly to short circuits.

There are several types of circuit breakers, each suited to different applications. Miniature Circuit Breakers (MCBs) are used for low voltage applications, typically found in residential and commercial buildings. Molded Case Circuit Breakers (MCCBs) handle higher currents and are used in industrial settings. Ground Fault Circuit Interrupters (GFCIs) protect against ground faults, which occur when current leaks to the ground, posing a shock hazard. Arc Fault Circuit Interrupters (AFCIs) detect and interrupt arc faults, which are dangerous electrical discharges that can cause fires.

A smart circuit breaker is an advanced type of electrical switch designed to automatically shut off electrical power in the event of an overload, short circuit, or other electrical fault. Unlike traditional circuit breakers, smart circuit breakers are integrated with digital technology and connectivity features that allow them to be controlled and monitored remotely. These devices often come with Wi-Fi or Bluetooth capabilities, enabling users to manage them through a smartphone app or a home automation system. Smart circuit breakers can provide real-time data on energy consumption, detect and report issues before they become serious, and offer insights into electrical usage patterns, thus enhancing both safety and efficiency. Additionally, they can be programmed to respond to various conditions, such as turning off specific circuits during peak demand times or in response to utility signals, contributing to better energy management and cost savings.

Smart circuit breakers work by combining traditional circuit protection mechanisms with digital technology and connectivity features. Like conventional circuit breakers, they have sensors that detect abnormal electrical conditions such as overloads or short circuits. When such conditions are detected, the breaker trips, interrupting the flow of electricity to the circuit and preventing damage to connected devices or appliances.

What sets smart circuit breakers apart is their ability to communicate with other devices and systems. They are equipped with microprocessors and communication modules that enable them to transmit data about electrical usage, fault detection, and status in real-time. This data can be accessed remotely through a smartphone app or a central control system, allowing users to monitor and manage their electrical systems from anywhere.

Smart circuit breakers can also be integrated into larger smart home or building automation systems, enabling them to interact with other smart devices such as thermostats, lighting controls, or energy management systems. This integration allows for more sophisticated automation and optimization of energy usage based on user preferences, schedules, or external factors like utility rates.

Overall, smart circuit breakers offer improved safety, enhanced monitoring and control capabilities, and greater flexibility in managing electrical systems compared to traditional circuit breakers.

Smart circuit breakers are built with a combination of traditional circuit protection components and advanced digital technology. At their core, they include the same essential elements found in conventional circuit breakers, such as a switch mechanism, trip unit, and current sensors.

The switch mechanism controls the flow of electricity through the circuit breaker, allowing it to be turned on or off manually or automatically. The trip unit is responsible for detecting abnormal electrical conditions, such as overloads or short circuits, and initiating the tripping action to interrupt the flow of current when necessary. Current sensors continuously monitor the electrical current passing through the breaker and provide feedback to the trip unit.

In addition to these basic components, smart circuit breakers incorporate digital microprocessors, communication modules, and sensors to enable their advanced functionality. These components allow the breaker to communicate with other devices and systems, transmit real-time data about electrical usage and status, and respond to commands or signals from users or automation systems.

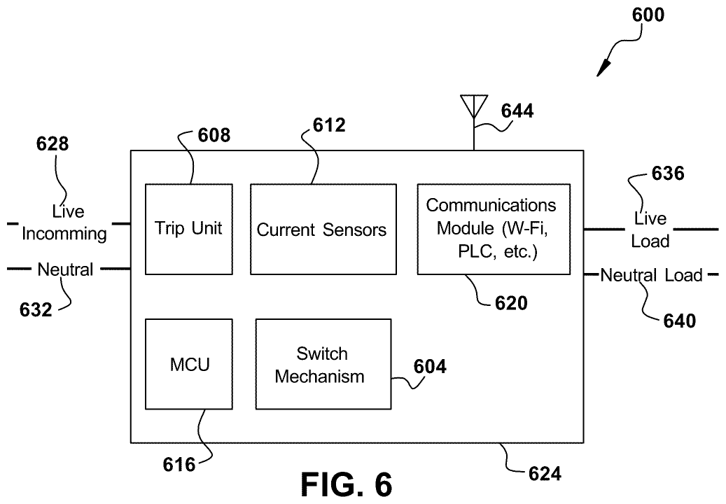

FIG. 6 illustrates a block diagram 600 of an example smart breaker that includes:

Switch Mechanism 604: This is the component that physically opens and closes the circuit. It can be manually operated or controlled electronically.

Trip Unit 608: The trip unit monitors the electrical current flowing through the circuit. When it detects an abnormal condition such as overload or short circuit, it triggers the switch mechanism to trip and interrupt the flow of current.

Current Sensors 612: These sensors continuously monitor the electrical current passing through the breaker and provide feedback to the trip unit.

Microprocessor or MCU 616: The microprocessor is the brain of the smart breaker. It processes data from the trip unit and sensors, controls the operation of the breaker, and manages communication with other devices or systems.

Communication Module 620: This module enables the smart breaker to communicate with other devices or systems, typically using protocols like Wi-Fi, Bluetooth, or Zigbee. It allows users to remotely monitor and control the breaker and integrates it into larger smart home or building automation systems.

Enclosure 624: All components are housed within a durable enclosure designed to protect them from environmental factors and ensure safe operation.

Also illustrated are live incoming power connection 628, neutral connection 632, live load power connection 636 and neutral load connection 640. Wireless communication is provided via antenna 644.

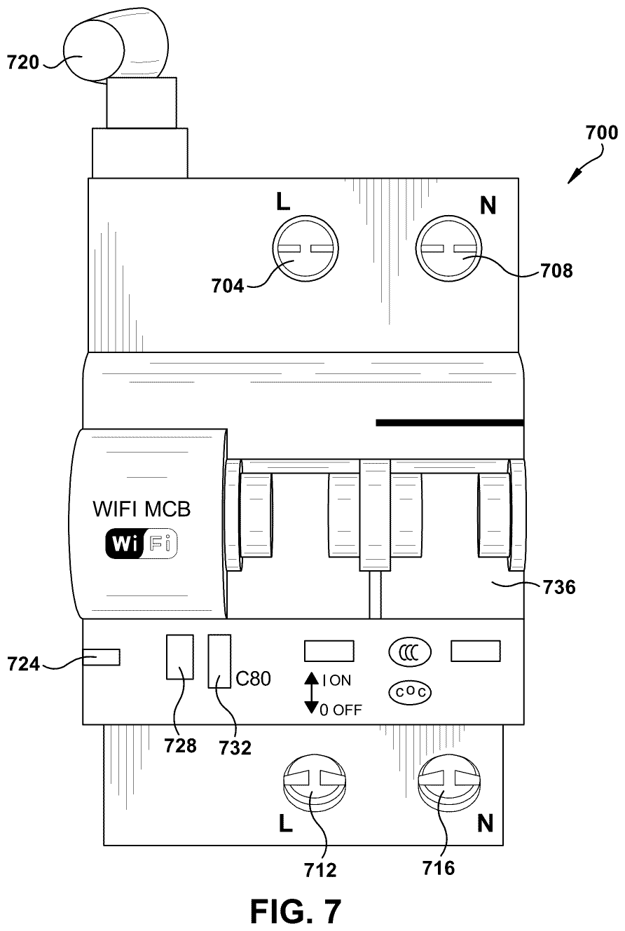

FIG. 7 illustrates an exterior view of an example embodiment of a smart circuit breaker 700. Included is live, incoming line 704 and neutral line 708. A load is connected to live load line 712 and neutral line 716. Smart circuit breaker data is communicated wirelessly via Wi-Fi antenna 720. Indicator light 724 provides a quick visual status of the breaker's condition or connectivity. A steady green light typically indicates normal operation, while no light signals that the breaker is off or unpowered. A red or flashing red light indicates a trip due to an overload, short circuit, or fault, which may persist until the breaker is reset. For breakers with communication features, a blinking light (green or blue) often means the breaker is in pairing mode or searching for a network, while a solid light confirms successful connection. Flashing patterns may signify firmware updates, communication errors, or diagnostic alerts. Some manufacturers use specific blink patterns or colors to convey additional diagnostic information, such as low voltage warnings, over-temperature conditions, or faults, providing a comprehensive overview of the breaker's status.

Quick/compatible indicator 728 provides visual or electronic feedback to confirm proper installation, compatibility with the electrical panel or system, and successful communication with monitoring or control hubs. It verifies that the breaker is securely connected and aligned, minimizing risks like loose connections or improper operation, and ensures the breaker is compatible with the panel or devices it is designed to support. Additionally, the indicator may signal communication status, such as successful pairing with Wi-Fi or a hub, and can help users or electricians quickly identify the correct breaker for maintenance or troubleshooting. It may also alert users to faults, such as misalignment, incorrect voltage ratings, or communication errors, enhancing safety and usability.

Safety lock 732 functions to prevent unauthorized or accidental operation by locking the breaker in the off or on position. It ensures compliance with lockout/tagout (LOTO) protocols, enhances safety during maintenance, prevents accidental activation or deactivation, and provides tamper resistance for secure installations.

Circuit breaker handle 736 is a physical lever used for manual control, allowing the breaker to be turned on, off, or reset after a trip. It provides a visual indication of the breaker's status on, off, or tripped, and serves as a manual override for safety and convenience, ensuring functionality even when electronic systems are unavailable or intervention is needed.

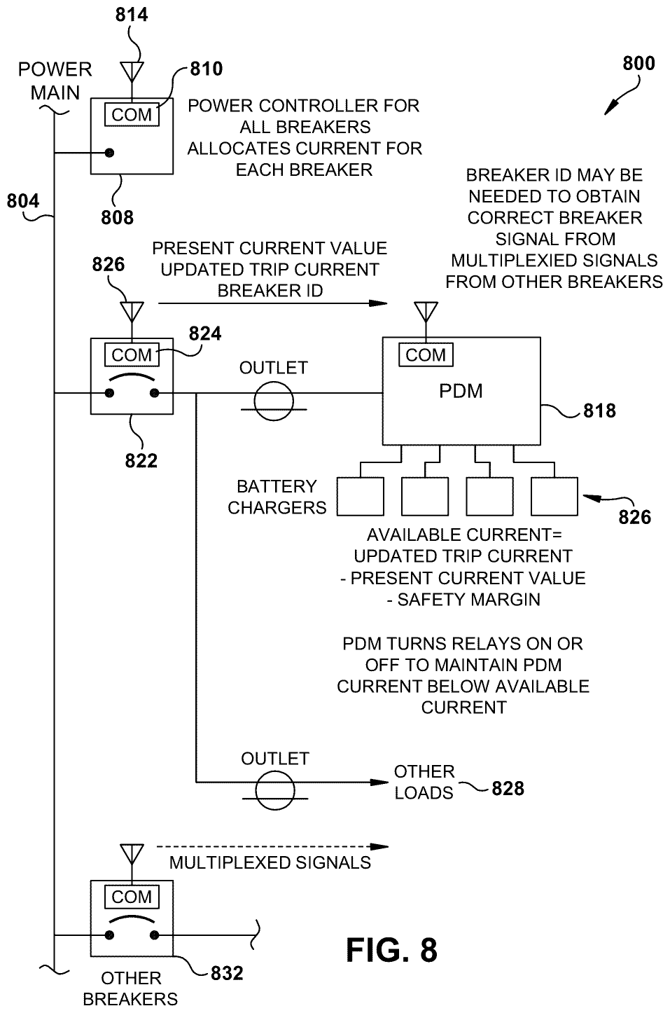

FIG. 8 illustrates a system diagram 800 of an example embodiment of a smart circuit breaker network for dynamic subload management wherein circuit breaker and control information is transferred wirelessly via Wi-Fi. Power is distributed by power main 804. Smart breaker power is allocated via power controller 808. Wi-Fi data exchange is accomplished via communication module 810 via antenna 814. Power is passed to one or more PDMs, such as PDM 818, where current is received via controllable breaker 822 in wireless data communication via communication module 824 and antenna 828. PDM 818 distributes power to one or more loads, such as battery chargers 826. Power distribution via breaker 822 may supply one or more other loads 830. Power controller 808 also suitably distributes power to one or more additional breakers, such as breaker 832.

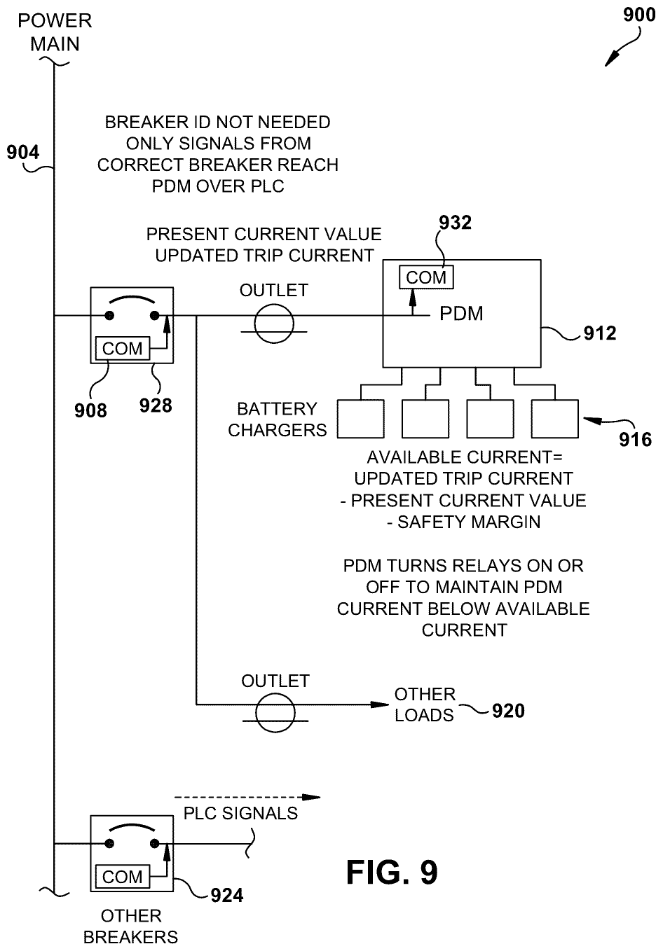

FIG. 9 illustrates a system diagram 900 of an example embodiment of a smart circuit breaker network for dynamic subload management wherein circuit breaker and control information is transferred via powerline communication (PLC). PLC transmits data over existing electrical power lines by superimposing a high-frequency modulated signal onto the standard low-frequency AC power signal. A PLC transmitter injects the modulated signal into the power lines, where it travels to a receiver that demodulates it to retrieve the data. This technology enables communication between devices without additional cabling.

Incoming power 904 is communicated through smart breaker 908 to PDM 912 which, in turn, distributes power to one or more loads, such as battery chargers 916. Smart breaker 908 may suitably supply additional loads 920. Incoming power 904 is also suitably applied to one or more additional smart breaker 924. PLC with smart breaker 808 is accomplished with PLC module 928. PLC with PDM 912 is accomplished with PLC module 932.

A PDM circuit suitably employs a microcontroller to accomplish the forgoing. Example Arduino code follows:

```
    #include <WiFi.h>
    #include <PowerlineCommunication.h> // Assuming library for powerline
  communication
    #include <CircuitBreaker.h> // Assuming library for smart circuit breaker
  communication
    // Define pin numbers for power outlet control
    #define OUTLET_PIN_1 2
    #define OUTLET_PIN_2 3
    // Define pin numbers for current load sensors
    #define CURRENT_SENSOR_PIN_1 A0
    #define CURRENT SENSOR PIN 2 A1
    // Define trip curve parameters (example values)
    #define TRIP_CURVE_THRESHOLD 20 // Example threshold for trip curve
    #define TRIP_CURVE_DELAY 500 // Example delay before trip action
    // WiFi credentials
    const char* ssid = “your_network_name”;
    const char* password = “your_network_password”;
    void setup( ) {
      // Initialize serial communication for debugging
      Serial.begin(9600);
      // Initialize WiFi connection
      connectToWiFi(ssid, password);
      // Initialize powerline communication
      initPowerlineCommunication( );
      // Initialize circuit breaker communication
      initCircuitBreaker( );
      // Initialize power outlet control pins
      pinMode(OUTLET_PIN_1, OUTPUT);
      pinMode(OUTLET_PIN_2, OUTPUT);
    }
    void loop( ) {
      // Read current load information from sensors
      float currentLoad1 = readCurrentLoad(CURRENT_SENSOR_PIN_1);
    float currentLoad2 = readCurrentLoad(CURRENT_SENSOR_PIN_2);
    // Receive trip curve data from circuit breakers
    float tripCurveData = receiveTripCurveData( );
    // Check if any load exceeds trip curve threshold
    if (currentLoad1 > TRIP_CURVE_THRESHOLD ∥ currentLoad2 >
TRIP_CURVE_THRESHOLD) {
    // Delay before taking action to prevent tripping
    delay(TRIP_CURVE_DELAY);
    // Check again if load still exceeds threshold after delay
        if (currentLoad1 > TRIP_CURVE_THRESHOLD ∥ currentLoad2 >
TRIP_CURVE_THRESHOLD) {
      // Power off the respective outlet to prevent tripping
      powerOffOutlet(currentLoad1, currentLoad2);
    }
    }
    // Continue monitoring power consumption and circuit breaker data delay(1000); //
    Adjust delay as needed for system responsiveness
    }
    void connectToWiFi(const char* ssid, const char* password) {
    Serial.print(“Connecting to ”);
    Serial.println(ssid);
    WiFi.begin(ssid, password);
    while (WiFi.status( ) != WL_CONNECTED) {
    delay(1000);
    Serial.println(“Connecting to WiFi...”);
    }
    Serial.println(“Connected to WiFi”);
    }
    void initPowerlineCommunication( ) {
    // Initialize powerline communication setup
    // Example: powerline.begin( );
    }
    void initCircuitBreaker( ) {
    // Initialize communication with smart circuit breaker
    // Example: breaker.begin( );
    }
          00float readCurrentLoad(int pin) {
      // Read current load from analog pin // Example:
    return analogRead(pin); }
    float receiveTripCurveData( ) {
      // Receive trip curve data from circuit breaker via WiFi or powerline
  communication
      // Example: return breaker.receiveTripCurveData( );
    }
    void powerOffOutlet(float load1, float load2) {
      // Turn off the respective outlet based on load information if (load1 >
      TRIP_CURVE_THRESHOLD) { digitalWrite(OUTLET_PIN_1, LOW);
      Serial.println(“Outlet 1 powered off to prevent tripping”); }
      if (load2 TRIP_CURVE_THRESHOLD) {
      digitalWrite(OUTLET_PIN_2, LOW);
      Serial.println(“Outlet 2 powered off to prevent tripping”); }
```

The example code provided implements a monitoring and control system for electrical circuits, focusing on preventing smart circuit breakers from tripping due to overloads. It includes functionalities for WiFi communication, powerline communication, and interaction with smart circuit breakers and current load sensors.

In the setup( ) function, initializations are performed: it establishes a serial connection for debugging purposes and initializes Wi-Fi connectivity by attempting to connect to a specified network using provided credentials. If the Wi-Fi connection succeeds, it prints a confirmation message to the serial monitor. The setup also initializes communication for powerline communication and circuit breaker communication, which are assumed to be managed by specific libraries or modules.

The loop( ) function is the core operational loop that continuously runs once the setup is complete. Within this loop:

It reads current load information from two analog sensors connected to analog pins (A0 and A1), presumably measuring current loads from different power outlets.

It receives trip curve data from smart circuit breakers, which define the current thresholds at which they would trip to protect the circuit.

It checks if any of the current loads exceed a predefined trip curvethreshold. If they do, it introduces a delay before rechecking to ensure the overload condition persists.

If the overload condition persists after the delay, the system takes action to prevent tripping: it turns off the respective power outlet associated with the high current load. This action is critical for preventing the smart circuit breakers from triggering and disrupting power supply.

Throughout the loop, the system continues to monitor and analyze the current load data and trip curve information, adjusting the power outlet status as necessary to maintain electrical circuit stability. The delays and checks are designed to prevent unnecessary power interruptions due to transient load spikes. Serial outputs are used for debugging and providing status updates on the actions taken, such as which outlet was powered off to prevent tripping.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. An electrical load management system comprising:
a) a smart circuit breaker configured to measure a present current flowing through said smart circuit breaker and transmit a breaker data signal that includes at least the present current value;
b) a power distribution module (PDM) that is operably connected to said smart circuit breaker; and wherein said PDM includes one or more relays to connect or disconnect subloads; and
c) a power controller that is communicatively coupled to said smart circuit breaker and said PDM; and wherein said power controller is configured to receive said breaker data signal and to determine an updated trip current associated with said smart circuit breaker; and wherein said PDM is configured to i) compute an available current based on said updated trip current and said present current value, and ii) selectively operate said one or more relays to keep a total load of said subloads within said available current.

2. The electrical load management system as defined in claim 1, wherein said smart circuit breaker further comprises a breaker ID transmitter that communicates a unique breaker identifier to said power controller; said power controller is configured to correlate said breaker data signal to said unique breaker identifier for load allocation purposes.

3. The electrical load management system as defined in claim 1, wherein said power controller is configured to aggregate present current values from a plurality of smart circuit breakers and allocate current to a plurality of PDMs to ensure each PDM remains below its respective breaker's updated trip current.

4. The electrical load management system as defined in claim 1, wherein said PDM comprises a battery charging circuit that charges one or more batteries; said one or more relays are configured and positioned to disconnect individual batteries from said battery charging circuit.

5. The electrical load management system as defined in claim 1, wherein said available current is computed by subtracting said present current value from said updated trip current and further subtracting a predetermined safety margin.

6. The electrical load management system as defined in claim 1, wherein said smart circuit breaker includes one or more communication interfaces selected from the group consisting of Wi-Fi, power line communication, Ethernet, Zigbee, and Bluetooth.

7. The electrical load management system as defined in claim 1, further comprising a user interface communicatively coupled to said power controller; said user interface is configured to display one or more of said present current, updated trip current, and/or status of each PDM in real time.

8. A method for preventing an electrical circuit from exceeding a trip threshold; said method comprising:
measuring, by a smart circuit breaker, a present current flowing through the breaker;
transmitting, from the smart circuit breaker to a power controller, a breaker data signal including at least the present current value and an updated trip current;
computing, by a power distribution module (PDM), an available current by subtracting said present current from said updated trip current and further subtracting a safety margin; and
selectively disconnecting, by the PDM, one or more loads via a set of relays to ensure said PDM's total load remains below said available current.

9. The method as defined in claim 8, further comprising receiving, at said power controller, a breaker ID from said smart circuit breaker and associating said breaker ID with said transmitted breaker data signal for system-wide load management.

10. The method as defined in claim 8, further comprising updating said computed available current periodically based on newly received present current values from said smart circuit breaker.

11. The method as defined in claim 8, further comprising charging, by said PDM, one or more batteries; each of said batteries is independently connected or disconnected by actuating a relay in response to said computed available current.

12. The method as defined in claim 8, further comprising aggregating, by said power controller, said present current values from multiple smart circuit breakers to coordinate said total current draw across multiple PDMs.

13. The method as defined in claim 8, further comprising communicating, by said power controller, a maximum allowable current draw to said PDM based on said updated trip current for said circuit breaker and said present current value.

14. The method as defined in claim 8, further comprising issuing an alert via a user interface if said total load of said PDM approaches said updated trip current within a predefined threshold.

15. A non-transitory computer-readable medium storing instructions that, when executed by one or more processors of a power distribution module (PDM), causes said PDM to:
receive a breaker data signal from a smart circuit breaker that indicates a present current value and an updated trip current;
calculate an available current by subtracting said present current from said updated trip current and further subtracting a safety margin; and
selectively cause the opening or closing one or more relays to maintain said PDM's current draw below said calculated available current.

16. The non-transitory computer-readable medium as defined in claim 15, wherein said instructions further cause said PDM to send status information to a power controller; said status information including a current consumption value of each subload.

17. The non-transitory computer-readable medium as defined in claim 15, wherein said instructions further cause said PDM to prioritize subloads based on predefined criteria so that lower priority subloads are disconnected first when current limits are approached.

18. The non-transitory computer-readable medium as defined in claim 15, wherein said instructions further cause said PDM to log trip events or near-trip events; said log events or near-trip events include timestamp information and/or load levels; said log events or near-trip events used for later diagnostic analysis.

19. The non-transitory computer-readable medium as defined in claim 15, wherein said instructions are used to cause said PDM to periodically poll said smart circuit breaker for updated present current values and trip thresholds.

20. The non-transitory computer-readable medium as defined in claim 15, wherein said instructions further cause said PDM to display, via a local or remote user interface, one or more type of information selected from the group consisting of real-time current usage, breaker status, and subload connection status.
